(19) United States
(12) Patent Application Publication
(10) Pub. No.: US 2011/0187557 A1
(43) Pub. Date: Aug. 4, 2011

(54) Method and arrangement for measuring electrical usage and curtailing electrical usage of individual electrical components

(75) Inventor: Christopher P. Dietzler, Glen Ellyn, IL (US)

(73) Assignee: Patrick Energy Services Inc.

(21) Appl. No.: 12/658,081

(22) Filed: Feb. 2, 2010

(51) Int. Cl. G08C 21/00; H01H 47/00; G05F 1/10

(52) U.S. Cl. 340/870.16; 307/131; 323/234; 340/870.28

(57) ABSTRACT

A method and system to curtail electrical use of a residential or commercial establishment to prevent a user from exceeding a user defined threshold amount. The method and system may monitor and control individual electrical components.

### FIELD OF THE INVENTION

The present invention relates to an apparatus and method to monitor, control and limit electrical usage. More specifically, aspects of the invention relate to apparatus and methods to monitor, control and limit electrical usage of individual electrical devices inside a commercial office building, residential home or places where plug in electric vehicles will be.

### BACKGROUND INFORMATION

Electricity usage is becoming a more important worldwide topic from both an economic and environmental standpoint. Most electrical production occurs from a host of technologies, wherein these technologies include burning of coal, burning of natural gas and nuclear energy. Electrical generation does have drawbacks because there can be serious impacts to the environment. The capital cost related to the construction of electrical generation facilities can be quite expensive and are limited to specific geographic locations as each type of facility requires certain site requirements. As electrical generation costs increases, there is an increasing demand to limit electrical consumption.

In order to decrease overall costs, utilities sometimes seek to limit electricity usage rather than increase generation capacity. Limiting customer electrical usage is generally called “Demand Side Management”, wherein electrical demand is limited by curtailing large power users, such as electric arc furnaces or large manufacturing plants. While large scale electrical users may be curtailed due to demand side management, little to no technologies exists for limiting electrical usage of the average home.

When electrical facilities are challenged as to their output and electrical demand is high on an electrical grid, a power utility may issue a warning of brown-outs or rolling black-outs according to the severity of the conditions. The electric utility may request that individuals turn off air conditioners, that are typically larger electricity users, but such requests are not demands on the customer, thus they can be ignored. Additionally, a majority of customers would not even receive a warning by a power utility that the grid has high demands, thus such warnings go unheeded.

From a cost perspective, as the costs of electricity increase, users may want to voluntarily curtail electrical usage to save on monthly costs. Other than actually reading the electrical meter in the house or building, there is little opportunity to identify if, in fact, an owner is exceeding the monthly budget for electrical usage. Even reading the electrical meter, however, only gives a rough estimate of the gross electricity use of the business or home. A person cannot identify, for example, that a majority of the electrical usage is due to use of an outdated refrigerator, electric stove or other appliance. Thus, there is no current technology that will indicate that the electrical usage is aberrant over a normal or expected usage for individual components. There is also no way of communications to determine the current unit price of power or to let a consumer know if the price of power is expensive.

There is a need for a method and system to accurately curtail electrical usage for a home or non-large scale business.

There is a further need for a method and system that will accurately provide for demand side management of small electricity users to help both users and electrical utilities curtail power demands on an electrical grid.

There is a still further need for a method and system that will allow a user to identify if a specific electrical item is aberrant in electrical usage.

There is also a need for a method and system that will accurately curtail electricity usage wherein the methods and system are easily installable and cost effective. There is also a need for a method to cost effectively identify what the current cost of electricity is during a day.

### SUMMARY OF THE INVENTION

It is therefore an objective of an aspect of the invention to provide a method and system to accurately curtail electrical usage for a home or non-large scale business.

It is a further objective of an aspect of the invention to provide a method and system that will accurately provide for demand side management of small electricity users to help both small electricity power users and electrical utilities curtail power demands on an electrical grid.

It is a further objective of an aspect of the invention to provide a method and system that will allow a user to identify if a specific electrical item is aberrant in electricity usage. It is a further objective to identify the cost of electricity to a home owner or user in a visual context so that the user will identify if the cost is excessive.

It is also an objective of an aspect of the invention to provide a method and system that will accurately curtail electricity usage that is easily installable, and cost effective.

The objectives of the invention are achieved as illustrated and described. In one example embodiment, an arrangement for monitoring and controlling electricity is provided. This embodiment comprises a base unit with a processing arrangement and a switch connected to the processing arrangement, wherein the processing arrangement is further configured to wirelessly accept data and a plug in unit configured with a wireless arrangement to wirelessly exchange data with the base unit. The plug in unit is configured to accept an electrical plug of an electrical device and the plug in unit is additionally configured to plug in to an electrical outlet. Additionally, the plug in unit is configured with a CPU system to measure an amount of electricity passing through the plug in unit and to transmit data relating to the measured amounts of electricity through the wireless arrangement

In another embodiment; the arrangement may be configured wherein the plug in unit is further configured with a switch configured to interrupt the amount of electricity passing through the plug in unit.

In another embodiment, the arrangement may be configured wherein the plug in unit is further configured with a color indicator.

In another embodiment, the arrangement may be further configured with an internet connection arrangement that is configured to accept and send information from the processing arrangement to the internet.

In another embodiment, a method to control electricity usage for an appliance, is provided. In this embodiment, the method comprises accepting electricity through a base unit, the electricity destined for electrical components, measuring an electricity amperage accepted through the base unit, measuring an actual electricity amperage passing through at least one plug in unit, comparing the amperage passing through the at least one plug in unit to an expected amperage passing through the at least one plug in unit; and one of restricting an electrical amperage at the plug in unit, activating a color indicator and sending data to the base unit when the actual electrical amperage passing through the at least one plug in unit exceeds the expected electrical amperage passing through the at least one plug in unit.

In another embodiment the method may further comprise receiving data at the base unit from the at least one plug in unit.

In a still further embodiment, the method may further comprise restricting an amperage at the base unit when the actual electrical amperage passing through the at least one plug in unit exceeds the expected electrical amperage passing through the at least one plug in unit.

In another embodiment, a program storage unit is provided. In this embodiment, the method is performed for monitoring and/or restricting electrical usage for an appliance, wherein the program storage unit is configured to perform the method steps of accepting electricity through a base unit, the electricity destined for electrical components, measuring an electricity amperage accepted through the base unit, measuring an actual electricity amperage passing through at least one plug in unit, comparing the electrical amperage passing through the at least one plug in unit to an expected electrical amperage passing through the at least one plug in unit, and one of restricting an electrical amperage at the plug in unit, activating a color indicator and sending data to the base unit when the actual electrical amperage passing through the at least one plug in unit exceeds the expected electrical amperage passing through the at least one plug in unit.

### BRIEF DESCRIPTION OF THE DRAWINGS

The present invention is best understood from the following detailed description when read in conjunction with the accompanying drawing. It is emphasized that, according to common practice, the various features of the drawing are not necessarily to scale. On the contrary, the dimensions of the various features are arbitrarily expanded or reduced for clarity. Like numerals denote like features throughout the specification and drawing.

FIG. 1 is diagram of a torroid transmitter placed over an electrical cord of a load, such as an electrical appliance, in accordance with an embodiment of the invention.

FIG. 2 is a diagram of a transmitter/transceiver with interrupting capability in accordance with an embodiment of the invention.

FIG. 3 is a diagram of a wireless transmitter placed over an electrical connection between a utility meter and a breaker panel, the wireless transmitter in connection with a base system of FIG. 5.

FIG. 4 is a diagram of a wireless transmitter/transceiver, in exploded view, attached to a cord of a load, in connection with the base system of FIG. 5.

FIG. 5 is a base system in a wireless connection configured to be in contact with the wireless transmitter of FIG. 3 and the wireless transmitter/transceiver of FIG. 4.

FIG. 6 is a method to monitor and curtail electrical usage of an electrical appliance in accordance with an embodiment of the invention.

FIG. 7 is a detailed layout of the electrical components of the plug in unit of FIG. 2.

### DETAILED DESCRIPTION

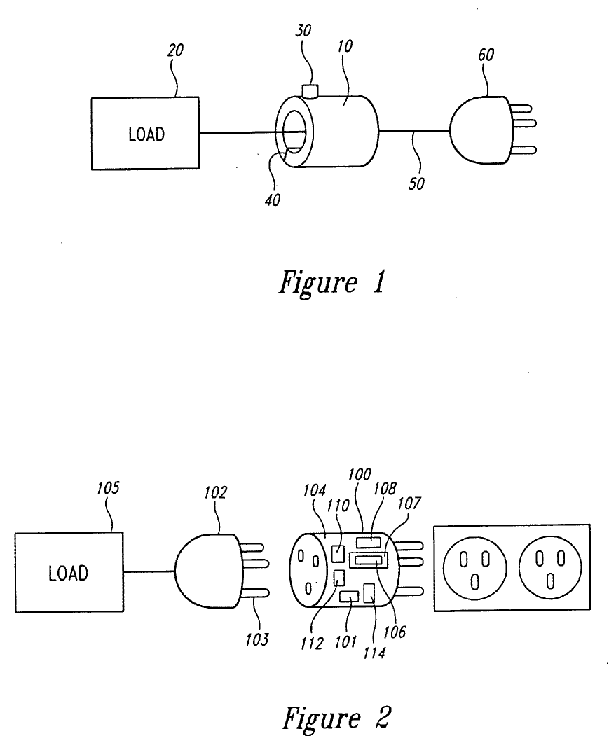

Referring to FIG. 1, in one example embodiment of the invention, a torroid device 10 for measuring the electrical amperage flowing through an electrical cord 50 to a load/electrical device 20 is illustrated. The torroid device 10 is configured with a transmitter 30 that is located on the exterior of the torroid device 10. A gap 40 is provided on the torroid device 10 such that the torroid device 10 may slip over an existing electrical cord 50. The device 10 is configured to measure the electrical amperage used by the load/electrical device 20 and with the transmitter 30 send information to a base system, described later. The load/electrical device 20 uses the electrical cord 50 to transmit electricity through a plug 60 to the device 20. The transmitter 30 may transmit the measured amperage to the base system and may also store information, over time, related to the amperage used over time.

Referring to FIG. 2, in one example embodiment, the invention may provide for a plug in unit 100 that has a wireless transmitter 108. The plug in unit 100 is configured to accept/receive a standard electrical plug, three pronged end 102 of an electrical cable that is attached to a load 105. Although described as a three pronged unit, a two pronged end may be used, thus dispensing with the ground attachment 103.

In one non-limiting embodiment, the plug in unit 100, has a plastic exterior. The outside 104 of the plug in unit 100 is made with an abrasive contact surface, in this instance, ridges, to allow an individual the ability to hold and remove the plug in unit 100 when in an installed condition.

The plug in unit 100 is impact resistant, therefore it can withstand impulse loading from drops and falls, that commonly occur. In one embodiment, the plug in unit 100 is further configured with an interchangeable fuse 106 to allow for surge protection of the electrical device/load 105 that is to be monitored. The interchangeable fuse 106, in this embodiment, is placed behind a snap cover 107 to allow an individual to quickly and accurately change the fuse 106. The fuse 106, in one embodiment, is a standard tubular link fuse. The unit 100 may also be configured to accept different size fuses, thereby allowing the unit 100 to monitor and protect smaller or larger electrical components as needed.

The plug in unit 100 is configured to receive and transmit data wirelessly, through an integrated wireless arrangement 108. The base system 500 may offer a short-range point to point communication capability. In the illustrated embodiment, the plug in unit 100 may operate through radio frequency identification or through a wireless sensor network, Bluetooth or other communication protocol.

The plug in unit 100 is also configured with a CPU system 110 that monitors electricity flowing through the unit 100. The CPU system 110 is surge protected from the electricity flowing through the unit 100. In the illustrated embodiment, the CPU system 110 is configured to be wirelessly addressable so that electricity running through the plug in unit 100 is not only monitored, but may also be throttled and/or stopped. In one embodiment, a switch 112 is incorporated into the plug in unit 100. The switch 112 is incorporated into a serial configuration to the electrical flow path. The switch 112 is controlled and linked to the CPU system 110 to be opened and closed upon demand. In one embodiment, the CPU system 110 is programmed with a maximum amount of electricity (amperage) that may flow through the plug in unit 100. When the CPU system 110 measures an amount of electricity (amperage) that is greater than the maximum amount of electricity (amperage) that may flow through the plug in unit 100, the CPU system 110 may activate the switch to cut off the electrical flow. In an alternative configuration, the CPU system 110 allows the electricity to flow through the plug in unit 100, but a color indicator 114 may be activated to allow a user to identify that the electrical apparatus is using greater amounts of electricity than the rates expected. The CPU system 110 may be programmed to allow an overflow amount of maximum electricity before color indicator initiation. In one embodiment, the overflow amount is ten (10) percent of the expected flow rate.

The CPU system 110 may also be configured to not only measure instantaneous rates of flow (amperage) through the plug in unit 100, but may also be configured to activate either the switch 112 or the color indicator 114 if the electrical usage exceeds the threshold amount for over a specified period of time. This period of time may be, for example, one hour.

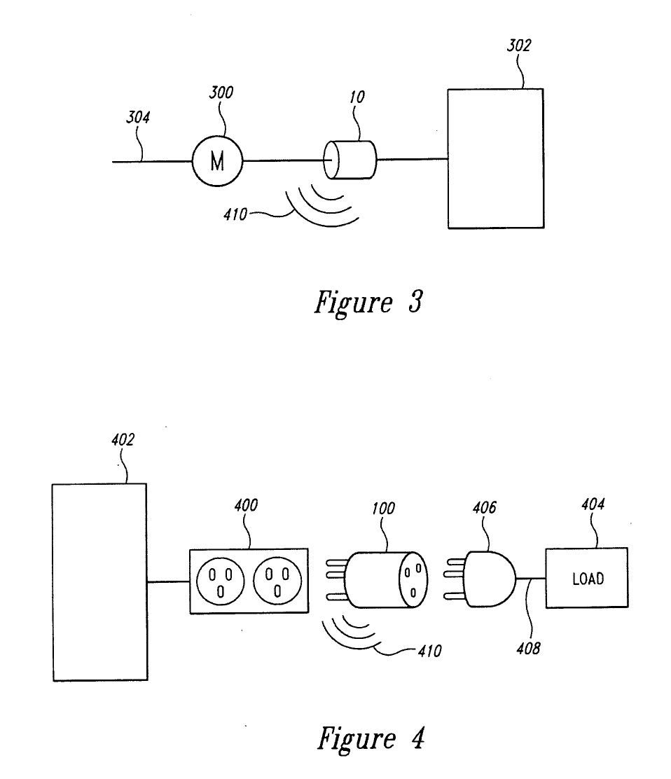

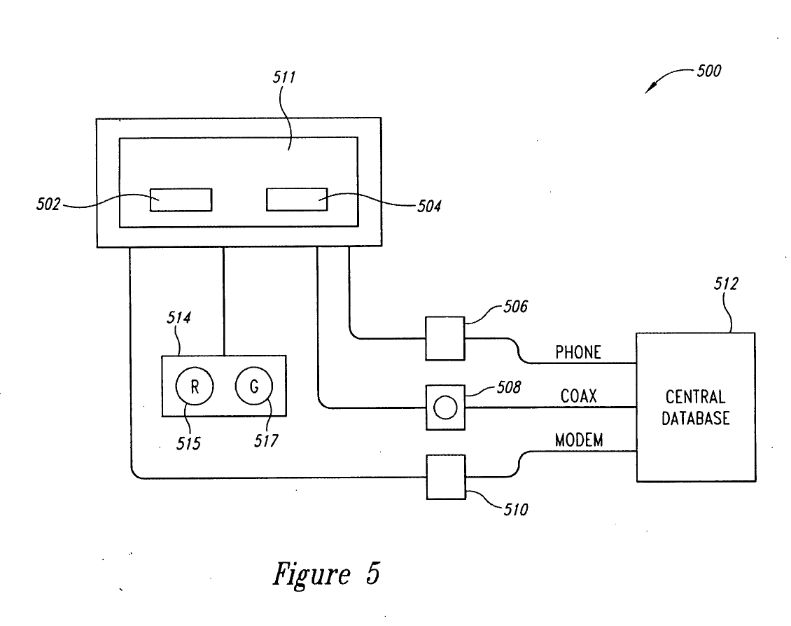

Referring to FIG. 3, the unit 10 of FIG. 1 is placed in an installed condition between a meter 300 and a breaker panel 302. The breaker panel 302 has numerous circuits to outlets. The unit 10 is in wireless contact with a base system of FIG. 5, described later. A utility line 304 feeds electrical energy to the meter 300.

Referring to FIG. 4, a plug in unit 100 is placed in an exploded installed view. The plug in unit 100 is in wireless contact to a base system of FIG. 5.

The plug in unit 100 is installed in an outlet 400 that is connected to a breaker panel 402. A load 404 is attached to the plug in unit 100 through a plug 406 and attached electrical cord 408. In each of FIGS. 3 and 4, the plug in unit 100 and the unit 10 are wirelessly connected to the base system illustrated in FIG. 5.

Referring to FIG. 5, and in all embodiments, the plug in unit 100 can wirelessly transmit and receive conditions/data to the base system 500. The base system 500 is configured to individually retain information from more than one plug in unit 100. A user may then ascertain if individual plug in units 100 have exceeded the amount of electricity that they were expected to use. This information is provided on a real time basis to the base system 500. The base system 500 may be connected, through the internet, to other systems to allow the base system 500 to be controlled from a remote location. The internet connection can be established through a cable or through standard telephone connection, described later. The internet connection may also be through a wireless 3G network system or other cellular telephone system.

In the illustrated embodiment, the base system 500 may have a LCD screen that allows a user to scroll through the individually addressed plug in units to identify what the status of the plug in units without individually reviewing each of the plug in units in their installed state. The base system 500 may be configured such that it fits on to the circuit breaker box of the home or commercial establishment. In the event of an electrical emergency, for example, by an electric utility, electrical usage may be throttled to a defined amount to limit the overall electrical usage of the home/establishment, thereby preventing electrical grid problems. Thus, an electric utility or individual may choose to interrupt only air conditioning services or refrigerator services.

The base system 500 is configured with solid state electronics, such as a processing arrangement 502, to allow for long term use with a minimum of malfunction possibility. The base system 500 is also configured with touch pad controls 504 that may be back lit for ease of identification. The touch pad controls 504 may be used to enter a passcode to allow access to the functional controls of the base system 500. The base system 500 may also be configured such that after a specified number of attempted accesses, the control of the base system 500 is locked. In the instance of a locked base system 500, the base system 500 may be programmed to notify an individual of the locked condition. Notification may be made by cellular telephone or through email connection.

As provided in the illustrated embodiment, the base system 500 may be configured to be hooked into a phone jack 506, a coaxial cable 508 or an internet connection 510. Through any of these connections, the base system 500 may interact with a central database 512. The central database 512 contains information related to individual units that use electricity. Through the central database 512, the system 500 can ascertain, by comparing the measured electrical usage of each of the plug in units to the expected electrical usage as provided in the central database 512, if the electrical usage traveling through the plug in unit 100 or unit 10 is excessive. A color indicator 514 on the system 500 may be illuminated to indicate if the amount of electrical usage is within expected parameters. The expected parameters may be set by the user through use of a keyboard or LCD touch screen 511 on the base system 500. In the illustrated embodiment, a red color indicator 515 indicates an over usage of electricity, while a green illumination 517 indicates that the usages is within expected parameters or is lower than expected. In addition to the above, a user may input into the base system 500 an amount of money that is expected to be spent for the period of interest. The user may specify the amount of time, in this case, a month. The amount of electricity that may be used can be estimated through identifying an approximate money/kW hour rate that is to be charged. The user can be notified, over time, of the progress of the system and the progress of charges over the time frame. A base system 500 may also project the amount of overage for the time period, if the constant rate of electrical usage continues.

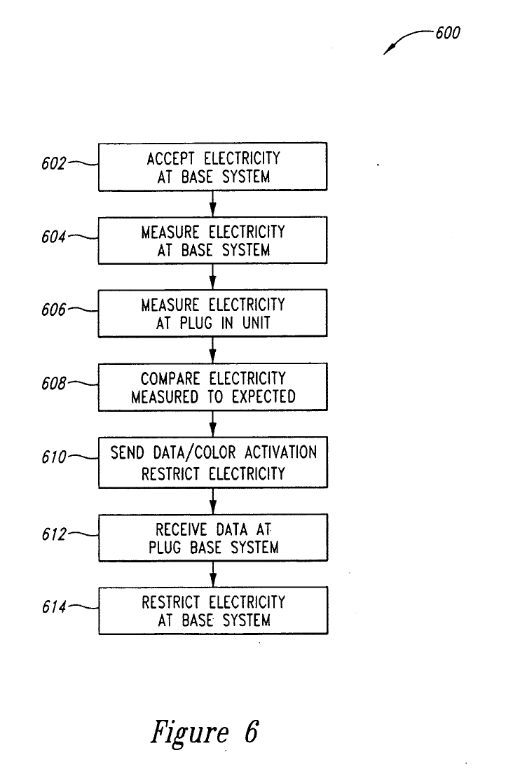

Referring to FIG. 6, a method 600 to control electrical usage for an appliance, is described. The method 600 provided comprises a first step of accepting electricity through a base system 500, the electricity destined for electrical components 602. A next step entails measuring an electricity amperage accepted through the base unit 604. The next step of the method entails measuring an actual electricity amperage passing through at least one plug in unit 606. A next step entails comparing the electrical amperage passing through the at least one plug in unit to an expected electrical amperage passing through the at least one plug in unit 608. A next step entails one of restricting an electrical amperage at the plug in unit, activating a color indicator and sending data to the base unit when the actual electrical amperage passing through the at least one plug in unit exceeds the expected electrical amperage passing through the at least one plug in unit 610. In another alternative step of the method, the method entails the step of receiving data at the base unit from the at least one plug in unit 612. In another alternative method step, the method 600 entails the step of restricting an electrical amperage at the base unit when the actual electrical amperage passing through the at least one plug in unit 100 or unit 10 exceeds the expected electrical amperage passing through the at least one plug in unit 614.

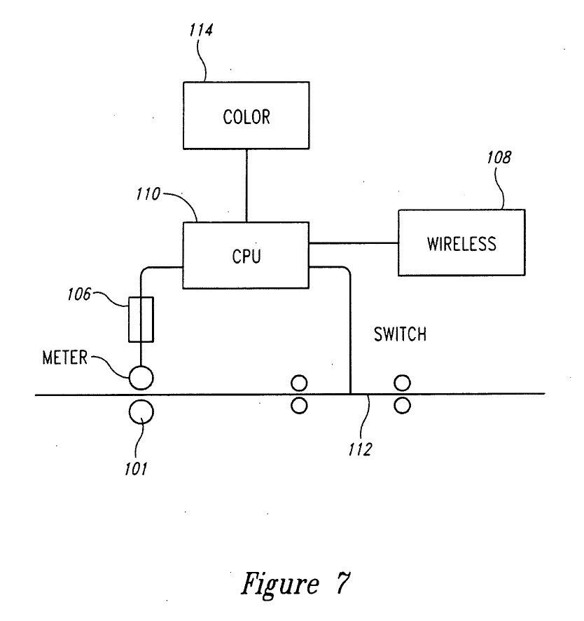

Referring to FIG. 7, an electrical layout for the components of the plug in unit 100 is illustrated. In the electrical layout, a meter 101 is positioned along the electrical pathway. The meter 101 is configured to provide data to the CPU 110 through the fuse 106. The CPU 110 is also connected to the switch 112 that may be opened upon command from the CPU 110. Data may be exported from the CPU 110 through the wireless arrangement 108. The color arrangement 114 is configured to be connected to the CPU 110.

Embodiments of the invention provide for real-time, customer oriented demand site management for small electrical users. Instead of large and expensive smart meters that only monitor the gross electrical usage that enters a dwelling or small business, embodiments of the invention provide for the customer to accurately determine which, if any, appliances are over using their individual amounts of electricity.

Embodiments of the invention are customizable for each type of apparatus monitored, therefore the apparatus may be a refrigerator, a television set, an air conditioner or other type apparatus.

Aspects of the invention allow for curtailing of the electrical usage to all or each one of the apparatus monitored, therefore a user may customize their electrical usage. This allows a consumer to limit the spending of funds on electricity according to their individual budgetary needs.

Aspects of the invention also provide for a cost effective solution to spending on electricity. To that end, aspects of the invention allow for an individual to spend relatively modest amounts of capital to be able to control costs within an average home or small business.

Aspects of the invention also provide a method and apparatus to allow utilities, if they are so equipped, to control demand side management issues on houses, through use of the internet or management system.

Aspects of the invention allow the relative pieces/components of the system to interface with conventional electrical systems, thereby allowing easy retrofit of particular homes without the need for hard wiring. Internet enabled connections may be used to allow groups of homes/houses/businesses to be linked together, if need be, to allow whole load centers to be controlled to prevent cascading electrical outages.

In a further embodiment, the invention may allow an individual or individuals to remotely control the electrical use of specific components of a house from a remote location to limit latent electrical use of apparatus. In an example embodiment, the electrical use of an electric hot water heater may be limited by a person on vacation when no other people are in the residence, saving substantial dollars. Moreover, such control of electrical devices can be used as a safety apparatus, wherein automatic shut off of an electrical device occurs when an electrical device uses abnormal amounts of electricity.

In example embodiments provided, materials used are conventional substances that are not exotic and cost effective to produce and maintain.

In the embodiments provided, a user may also access control features of the unit 10 through a telephone line connection. Individual units 10 may be interconnected together so that a centralized server may control electrical distribution from a remote location. Demand side management, therefore, is possible where a utility may address the unit 10 and disconnect non-essential electrical usages such as outdoor lighting. While one unit 10 addressed in this manner may save minimal amounts of electricity, whole neighborhoods may be simultaneously and momentarily interrupted, thereby providing significant energy savings for a utility. This, in turn, may allow power companies to take credit during buying and selling of electricity, for having an interruptible service. Consumers who accept such contracts for interruptible service with electric utilities may receive a credit on energy purchases, or in the alternative, may receive reduced electricity rates. Such interruptible service can help an electric utility from having to spend more capital dollars on base load or peaking utility plants. Currently, utility demand side management systems may interrupt tens or perhaps 100 MWh of demand in the case of an electric arc furnace. Demand side management of residential customers is largely unexplored except for emergency voltage reductions or curtailment during electrical crises. Selective curtailment of specific appliances inside the home has not been accomplished. Thus, while most electric utilities produce the bulk of their energy for residential use, no attempts to selectively address electrical usage on an appliance basis has been accomplished. The unit 10 may also connect to smart meters installed by utilities to interact with their established functions. Such interaction may be through direct/hard wire connection or through wireless communication. In another embodiment, an apparatus is provided to let the electricity consumer identify the cost of electricity that is on the open market for purchase. In this embodiment, either a wired or wireless connection is used to identify a spot price for electricity cost for the consumer. This electricity cost is then displayed to the consumer by a color coded light. In one example embodiment the color coded light is located on a control panel so that the user may quickly identify the color and if the cost of electricity is expensive. The color coded light and such capabilities may be incorporated into to the unit 10, as a non-limiting example, or other components described herein.

The methods and systems provided allow a user to remotely identify the amount of electricity that is being used on a bulk and individual/per appliance basis. Users may then forecast their exact usages of electricity over the course of a year and provide sufficient funds for such expenditures.

In an alternative embodiment, the method and apparatus may be used to charge larger types of apparatus, such as electric vehicles. Such electric vehicles may be, for instance in a non-limiting embodiment, an electric car or electric scooter. The method and apparatus may be configured such that overcharging of the vehicle is prevented by the system. Thus, a user, through a base station or unit 10 may be configured to dispense a selected amount of electricity, at given parameters, to the electric vehicle. After the parameters have been met by the electricity provided, they unit 10 may shut off the power to the vehicle.

The system and method may be further configured to interface with the onboard electronics of the electric vehicle to terminate electricity delivery upon a signal provided by the electric vehicle. The interconnection between the unit 10 and the electric vehicle may be done through a wireless connection, for instance. All wireless connections between the unit 10 and the electric vehicle may be secured or unsecured to prevent tampering with the electric vehicle.

The system and method may also be configured such that the unit 10 may monitor the charge of the vehicle, without actually providing an electrical connection to the vehicle, wherein a user may monitor the charge of the vehicle from a remote location.

In all embodiments, the unit 10 may also allow for switching of electricity from source providers. To that end, if a source provider may be a more environmentally friendly alternative for providing electricity, the user may dictate to the unit 10 that the electricity should be provided from that source. In one embodiment, if a house is fitted with solar cells, the unit 10 may be directed to provide electricity from the solar cells to the uses in the house first, rather than accepting power from the electrical grid. The unit 10 may also share, the loads, according to user defined parameters, so that items may be powered according to the wishes of the user. The user may dictate what apparatus gets powered and when the power gets delivered.

The method and system provided eliminates costly conductor upgrades to wires and infrastructure so that a residential house, for instance, does not need to be uneconomically upgraded. The apparatus may be placed in a garage of a residential area, or a charging station for an electric vehicle recharging station.

In the foregoing specification, the aspects of the invention have been described with reference to specific embodiments thereof. It will, however, be evident that various modifications and changes may be made thereunto without departing from the broader spirit and scope of the invention as set forth in the appended claims. The specification and drawings are accordingly to be regarded in an illustrative rather than in a restrictive sense.

What is claimed is:

1. An arrangement for monitoring and controlling electricity comprising:
a base unit with a processing arrangement and a switch connected to the processing arrangement, wherein the processing arrangement is further configured to wirelessly accept and transmit data; and
a plug in unit configured with a wireless arrangement to wirelessly exchange data with the base unit, wherein the plug in unit is configured to accept an electrical plug of an electrical device and the plug in unit additionally configured to plug in to an electrical outlet, the plug in unit configured with a CPU system to measure an electricity amperage passing through the plug in unit and to transmit data relating to the measured amounts of electricity through the wireless arrangement, wherein the plug in unit is further configured with a switch configured to interrupt the amount of electricity passing through the plug in unit.

2. The arrangement according to claim 1, wherein one of the plug in unit and the base unit is further configured with a color indicator that is configured to illuminate based on an amount of electricity that has passed through the one of the plug in unit and the base unit.

3. The arrangement according to claim 1, wherein the base unit is further configured with at least one of an internet connection arrangement, a coaxial connection and a telephone line, the arrangement configured to accept and send information from the processing arrangement to at least one of the internet and an outside source.

4. A method to control electricity usage for an appliance, comprising:
accepting electricity through a base unit, the electricity destined for electrical components;
measuring an electricity amperage accepted through the base unit;
measuring an actual electricity amperage passing through at least one plug in unit;
comparing the electrical amperage passing through the at least one plug in unit to an expected electrical amperage passing through the at least one plug in unit for a defined electrical load; and
one of restricting an electrical amperage at the plug in unit, activating a color indicator and sending data to the base unit when the actual electrical amperage passing through the at least one plug in unit exceeds the expected electrical amperage passing through the at least one plug in unit.

5. The method according to claim 4, further comprising:
receiving data at the base unit from the at least one plug in unit.

6. The method according to claim 5, further comprising:
restricting an electrical amperage at the base unit when the actual electrical amperage passing through the at least one plug in unit exceeds the expected electrical amperage passing through the at least one plug in unit.

7. A program storage unit configured to perform a method to control electricity usage for an appliance, the program storage unit configured to perform the method steps of:
accepting electricity through a base unit, the electricity destined for electrical components;
measuring an electricity amperage accepted through the base unit;
measuring an actual electricity amperage passing through at least one plug in unit;
comparing the electrical amperage passing through the at least one plug in unit to an expected electrical amperage passing through the at least one plug in unit; and
one of restricting an electrical amperage at the plug in unit, activating a color indicator and sending data to the base unit when the actual electrical amperage passing through the at least one plug in unit exceeds the expected electrical amperage passing through the at least one plug in unit.
